(19) United States
(12) Patent Application Publication
(10) Pub. No.: US 2026/0284772 A1
(43) Pub. Date: Sep. 24, 2026

(54) Tungsten Inert Gas (TIG) Welding Control Unit and Welding Apparatus Using Same

(71) Applicant: Alexander Nikolas Krol, Franklin, OH (US)

(72) Inventor: Alexander Nikolas Krol, Franklin, OH (US)

(21) Appl. No.: 19/170,731

(22) Filed: Apr. 4, 2025

Related U.S. Application Data
(63) Continuation-in-part of application No. 19/082,865, filed on Mar. 18, 2025, now abandoned.

(51) Int. Cl. B23K 9/167; B23K 9/095; B23K 9/16

(52) U.S. Cl. CPC B23K 9/167; B23K 9/0956; B23K 9/164

(57) ABSTRACT

A welding apparatus having a welding electrode, a shielding gas supply supplying shielding gas supply to a front side and a back side of a part to be welded, the improvement includes a flow sensor connected to the gas supply sensing if shielding gas is flowing on the front and/or back side of the part, and a controller connected to the flow sensor, the controller interrupting operation of the welding electrode when sensing lack of flow in shielding gas on either side.

### FIELD OF INVENTION

The present invention relates to the field of welding. More particularly, the invention relates to a safety control unit for Tungsten Inert Gas (TIG) welding.

### BACKGROUND OF THE INVENTION

### Prior Art

Tungsten Inert Gas (TIG) welding, also known as Gas Tungsten Arc Welding (GTAW), is a precise welding process that uses a non-consumable tungsten electrode to create an arc that melts a base metal. This process is shielded by an inert gas, usually argon or helium, to prevent contamination of the weld area. TIG welding is known for its high-quality, clean welds and is commonly used for welding thin materials, stainless steel, aluminum, and exotic metals like titanium.

### How TIG Welding Works

Electrode and Arc: A tungsten electrode creates an arc between itself and the workpiece.
Shielding Gas: Argon or helium gas is used to shield the weld from atmospheric contaminants, such as ambient air which commonly has nitrogen (78%), oxygen (21%), with smaller amounts of argon, carbon dioxide, and other trace gases. In order to perfect welds, the shielding gas is used about the whole weld, for example, the front and back side of the part.
Filler Material (Optional): A separate filler rod may be used if needed.
A Remote such as a Foot Pedal or Hand Control: Welders often use a remote such as a foot pedal to start and end the welding process and to control the heat input, allowing for fine adjustments.
Cooling System: Water or air cooling prevents overheating, especially in high-amperage applications.

### Background of TIG Welding

TIG welding was developed in the 1940s by Russell Meredith, an engineer at Northrop Aircraft, to meet the demands of welding lightweight aluminum and magnesium in the aerospace industry. Before this innovation, joining such metals was challenging due to oxidation and contamination. The process quickly gained popularity in aviation, automotive, and industrial fabrication due to its precision, strength, and clean results.

Advantages of TIG Welding reside in high-quality, clean welds with minimal spatter; precise control over heat and weld bead size; ability to weld thin materials and exotic metals. Additionally, if done correctly, it produces strong, ductile welds. No flux or slag is required, reducing post-weld cleanup.

Disadvantages of TIG Welding is that lower process compared to Metal inert gas (MIG) welding. It requires skilled operators due to the manual control involved, which also introduces potential for human error. This can be very problematic particularly when it comes to the aeronautical industry where a part failure can be catastrophic to human life. It is higher equipment cost due to power supplies and cooling systems. TIG welding remains a preferred method in industries requiring precision, such as aerospace, medical, and automotive fabrication.

This said, there remains a need to improve the method and devices for welding, particularly, TIG Welding to overcome deficiencies in the art. The instant invention addresses the problems and provides a solution to problems in the field.

### SUMMARY OF THE INVENTION

It is an object to improve welding.

It is another object to improve welding which uses backing gas.

Another object of the invention it to provide an improved welding device.

Still another object is to ensure control of proper welding techniques.

Another object is to provide a control device in a welding apparatusrequiring backing gas application.

Accordingly, one embodiment of the invention is directed to a welding apparatus, which includes:
a welding electrode;
a shielding gas supply;
at least one shielding gas supply supplying shielding gas adjacent said welding electrode and for delivering shielding gas on a side of a part to be welded;
a sensor disposed adjacent the part to sense a gas indicative of presence of the shielding gas; and
a controller connected to said sensor, said controller interrupting operation of said welding electrode when receiving a signal indicating lack of shielding gas.

More particularly, one embodiment includes a welding apparatus requiring backing gas. The apparatus includes a welding electrode, preferably a tungsten electrode creates an arc between itself and the workpiece, a shielding gas supply, preferably argon or helium, (or other mixtures of argon, helium, carbon dioxide, nitrogen, hydrogen) wherein the shielding gas supply has a first feed line adjacent the electrode and a second feed line for use on a back side of a part to be welded. A flow sensor is disposed at least in the second feed line which senses if the shielding gas is flowing through the second feed line. Connected to the flow sensor is a controller which controls the signal circuit provided by a remote such as a foot pedal or hand control. This signal is interpreted by the welding machine to provide electrical power to the electrode. When this signal is interrupted, then no power is sent to the electrode and no welding can occur. The electrode is rendered inoperable to weld when no flow is sensed in the second feed line (by breaking connection in the signal circuit) and operable when flow is detected (connecting the signal circuit). Foot Pedal and/or Hand Control is connected to the controller and foot pedal to control the heat input, allowing for fine adjustments.

A further aspect of the invention is directed to a welding apparatus having a welding electrode, a shielding gas supply delivering shielding gas adjacent the welding electrode and for delivering shielding gas on a side of a part to be welded. The improvement includes:
a sensor generating a signal indicative of presence of shielding gas to the part; and
a controller connected to said sensor, said controller interrupting operation of the welding electrode when receiving a signal indicative of lack of shielding gas.

More particularly, one embodiment of the invention envisions an option to sense the presence of backing gas by measuring the oxygen levels with an O2 sensor. Since the purpose of backing gas is to displace the oxygen from the weld, then when the drop in oxygen levels is detected, then this implies that backing gas is present. This sensor can also be placed in the part itself (or connected to the part in some way like a tube) to detect the oxygen levels inside the part to be welded. By placing the sensor in this location, this will protect against backing gas being left off AND being disconnected from the part to be welded. This sensor can be placed inline with the backing gas line as well. Other gas sensors can also be used to sense specific backing gas like an Argon sensor for Argon, or CO2 sensor for CO2, Helium sensor for Helium, etc.

Still another embodiment provides a welding apparatus, which includes:
a welding electrode;
a shielding gas supply supplying shielding gas supply to at least one of a front side and a back side of a part to be welded;
a sensor connected to the gas supply generating a signal indicative of presence of shielding gas to at least one front side and back side; and
a controller connected to the sensor, the controller interrupting operation of the welding electrode when receiving the signal indicative of lack of shielding gas to the at least one front side and back side.
Filler Material (Optional): A separate filler rod may be used if needed.
Cooling System: Water or air cooling prevents overheating, especially in high-amperage applications.

### BRIEF DESCRIPTION OF THE DRAWINGS

FIG. 1 is a schematic illustrating the invention.

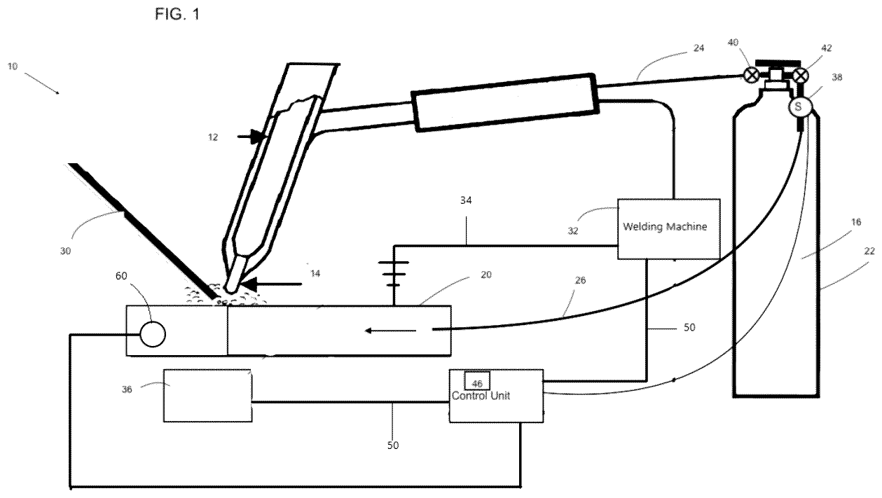

### DETAILED DESCRIPTION OF THE DRAWINGS

Referring now to the drawings, the welding apparatus of the invention is generally referred to by the numeral 10 and includes a tungsten inert gas (TIG) welding control unit 12. The welding apparatus 10 includes a welding electrode 14, preferably a tungsten electrode creates an arc between itself and the workpiece, hence a TIG Torch 12 which is a handheld tool that delivers the welding arc.

A shielding gas 16, preferably argon or helium, to protect the weld area 16 on part 20 from contamination. A gas tank 22 holds the shielding gas 16, usually argon or a mix of argon and helium, (optionally argon, helium, carbon dioxide, nitrogen, hydrogen or mixtures thereof) wherein the shielding gas 16 is in cummunication with a first feed line 24 adjacent the electrode and a second feed line 26 for use on a back side of a part 20 (here seen as inside a tube) to be welded. This ensures a clean weld by preventing oxidation and contamination.

A flow valve 40, 42 controls and measures the flow rate of the shielding gas 16. This ensures a consistent gas supply for a stable welding arc.

Filler Material 30 is optional. A separate filler rod may be used if needed as understood in the art.

The welding machine unit 32 provides necessary electrical current for welding. The apparatus 10 can operate in AC (for aluminum) or DC (for steel and stainless steel) modes. The unit 32 usually has controls for adjusting voltage, amperage, and arc stability.

A ground line 34 connects to the workpiece to complete the electrical circuit. This ensures proper electrical grounding for a stable arc.

A remote such as a foot pedal 36 starts and ends the welding process and controls the amperage while welding. This allows for precise heat input, crucial for welding thin materials.

A flow sensor 38 is disposed at least in the second feed line 26 which senses if the shielding gas 16 is flowing through the second feed line 26. The user must open the valves 40, 42 in order to permit gas flow. As mentioned sometimes the user forgets to open the valve 42 and welds occur seemingly well on a front side of part 20 when in fact the inside (or back side) is not properly purged with gas 16 resulting in a defective part 20.

Accordingly, one embodiment of the instant invention provides a flow sensor 38 which is disposed in communication with valve 42 and second feed line 26 and connected to a controller 46 having a processor to control signal circuit 50 connection. In this regard, the electrode 14 is rendered inoperable to weld when no flow is sensed in the second feed line 26 (by controller 46 breaking connection in the signal sircuit 50) and operable when flow is detected (by controller 46 connecting the signal sircuit 50). A remote such as a foot pedal 36 and/or hand control is connected to the controller 46 to control the starting and ending of the welding process and amperage control.

It is contemplated that the connections between the sensor 38, controller 46, foot pedal 36 can be hard wired or wireless and include the hardware required to faciltate either mode of connection.

Another embodiment of the invention envisions an option to sense the presence of backing gas 16 by measuring the oxygen levels with an O2 sensor 60. Since the purpose of backing gas 16 is to displace the oxygen from the weld, then when the drop in oxygen levels is detected, then this implies that backing gas 16 is present. This method of sensing gas is likely more accurate and with no moving parts. This sensor 60 can also be placed in the part itself (or connected to the part in some way like a tube) to detect the oxygen levels inside the part 20 to be welded. By placing the sensor 60 in this location, this will protect against backing gas 16 being left off AND being disconnected from the part 20 to be welded. This sensor 60 can be placed inline with the backing gas line 26 as well. Other gas sensors can also be used to sense specific backing gas like an Argon sensor for Argon, or CO2 sensor for CO2, Helium sensor for Helium, etc.

While the preferred embodiment has been set forth above, there are modifications, derivations and improvements which are believed to be within the appended the claims are accordingly entitled to protection within the scope of the claims.

What is Claimed is:

1. A welding apparatus, which includes:
a welding electrode;
a shielding gas supply;
at least one shielding gas supply supplying shielding gas adjacent said welding electrode and for delivering shielding gas on a side of a part to be welded;
a sensor disposed adjacent the part to sense a gas indicative of presence of the shielding gas; and
a controller connected to said sensor, said controller interrupting operation of said welding electrode when receiving a signal indicating lack of shielding gas.

2. The welding apparatus of claim 1, wherein said at least one shielding gas supply includes a first feed line connected to said shielding gas supply and delivering shielding gas adjacent said welding electrode and a second feed line connected to said shielding gas supply and for delivering shielding gas on a back side of a part to be welded.

3. The welding apparatus of claim 2, wherein said controller controls a signal circuit connection into a remote circuit to one of a foot pedal and a hand control of said welding apparatus such that said welding apparatus cuts power to said welding electrode rendering it inoperable to weld when receiving a signal indicative of lack of shielding gas.

4. The welding apparatus of claim 3, which is further characterized such that said controller breaks connection in said signal circuit connected to said remote circuit to the welding apparatus which in turn breaks power to said welding electrode rendering it inoperable and joins connection in said signal circuit connected to said remote circuit to render operable when receiving a signal indicative of presence of shielding gas.

5. The welding apparatus of claim 1, which includes one of a remote control which includes one of a foot pedal and a hand control, which is connected to said controller to control heat input and welding.

6. The welding apparatus of claim 1, wherein said welding electrode is a tungsten electrode.

7. The welding apparatus of claim 1, wherein said shielding gas includes at least one of argon, helium, carbon dioxide, nitrogen, hydrogen or mixtures thereof.

8. In a welding apparatus having a welding electrode, a shielding gas supply delivering shielding gas adjacent the welding electrode and for delivering shielding gas on a side of a part to be welded, the improvement includes:
a sensor generating a signal indicative of presence of shielding gas to the part; and
a controller connected to said sensor, said controller interrupting operation of the welding electrode when receiving a signal indicative of lack of shielding gas.

9. The welding apparatus of claim 8, wherein the sensor senses to one of a back side and a front side of the part.

10. A welding apparatus, which includes:
a welding electrode;
a shielding gas supply supplying shielding gas supply to at least one of a front side and a back side of a part to be welded;
a sensor connected to said gas supply generating a signal indicative of presence of shielding gas to at least one front side and back side; and
a controller connected to said sensor, said controller interrupting operation of said welding electrode when receiving the signal indicative of lack of shielding gas to said at least one front side and back side.
